(19) United States
(12) Patent Application Publication
(10) Pub. No.: US 2010/0207991 A1
(43) Pub. Date: Aug. 19, 2010

(54) LIQUID EJECTING APPARATUS

(75) Inventor: Yoshihiro KOIZUMI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/706,259

(22) Filed: Feb. 16, 2010

(30) Foreign Application Priority Data
Feb. 16, 2009 (JP) 2009-032788

(51) Int. Cl. B41J 2/165

(52) U.S. Cl. 347/32

(57) ABSTRACT

A liquid ejecting head for ejecting a liquid includes a cap that abuts a nozzle forming surface, thereby surrounding a nozzle. A cap holder biases the cap toward the liquid ejecting head. The cap holder can move in a first direction toward and away from the liquid ejecting head. A carrier reciprocates in a second, orthogonal direction. The carrier reciprocates in the second direction to reciprocate the cap holder in the first direction with a cam mechanism between an abutting position in which the cap abuts the liquid ejecting head and a flushing position in which the cap is spaced apart from the liquid ejecting head. The cap moves to a first flushing position when the cap moves from the abutting position to the flushing position, whereas the cap moves to a second flushing position when the cap moves from a non-abutting position to the flushing position.

This application claims the benefit of Japanese Patent Application No. 2009-032788, filed Feb. 16, 2009, which is expressly incorporated herein by reference in its entirety.

### BACKGROUND

1. Technical Field

The present invention relates to a liquid ejecting apparatus.

2. Related Art

An ink jet recording apparatus is widely known as one of liquid ejecting apparatuses. An ink jet recording apparatus includes a recording head for ejecting (discharging) an ink drop (a liquid). A droplet is ejected from a recording head onto a recording medium such as paper on which recording (printing) is performed while relatively moving the recording head and the recording medium. In addition, an ink jet recording apparatus includes a cap. A cap has an abutting position (a capping position) in which the cap abuts on a recording head and has a flushing position in which the cap is spaced apart from a recording head. In a capping position, a cap is biased toward a recording head with a spring to abut on a nozzle forming surface of the recording head so as to surround a nozzle, so that the drying of the recording head can be prevented. The preliminary ejection of ink can be performed in a flushing position to remove thickened ink in a nozzle.

A cap can be moved with a cam mechanism (see JP-A-2007-83706, for example). In such an apparatus, the cap is moved by being driven by a motor. Specifically, for example, a cap holder is disposed so as to be able to be vertically moved with respect to a carrier which is horizontally reciprocated with a motor. The cap is supported with a spring in the cap holder. A cam groove is formed on the carrier, and a cam rod of the cap holder engages with the cam groove. The cam groove has a flat portion and an inclined portion extending from the flat portion. The cam rod is disposed at the flat portion of the cam groove to dispose the cap in the capping position, and the cam rod is disposed at a predetermined position of the inclined portion of the cam groove to dispose the cap at the flushing position. Although the cap holder is downwardly spring-loaded in the capping position (in a capping state), the cap holder is not moved because the cam rod of the cap holder is positioned in a flat area (the flat portion) of the cam groove of the carrier. In cases where a printing instruction (a printing start instruction) is received, the cam rod of the cap holder is released from the flat area of the cam groove of the carrier to be moved to the flushing position which is located midway in the declined portion of the cam groove.

A cap is moved from a capping position to a flushing position by any one of the following two manners: bringing down a cap holder from a capping position to directly transfer a cap to a position in which flushing is performed (a first manner); and bringing down a cap from a capping position to a position beyond a flushing position, and then the cap is lifted to be transferred to a position in which flushing is performed (a second manner).

In the first manner, in cases where a cap holder is brought down from a capping state, the cam rod of the cap holder is swiftly brought down due to a downward spring load when the cam rod is released from the flat area of the cam groove of a carrier, so that it is difficult to accurately stop the cap holder at a predetermined position (a flushing position) (a cap is brought down exceeding a controlled variable of a motor). In cases where the cap is moved down considerably, the distance between the cap and the nozzle forming surface of a recording head is increased, so that ink drops cannot land on the cap during flushing, leading to a tendency to generate mist.

On the other hand, in the second manner, in other words, in cases where a cap is first brought down from a capping state and then lifted to a flushing position to perform flushing, the cap can be accurately stopped so as to be positioned at a predetermined height, with the result that mist is not formed. However, the starting time from receiving a printing instruction (a printing start instruction) to actually starting printing on paper is increased. In addition, in a mechanism in which the movement of a cap is performed only by the rotation of a motor in a single direction, because the cap can be lifted only after the cap is first moved down completely, a further additional time is required.

### SUMMARY

An advantage of some aspects of the invention is that it provides a liquid ejecting apparatus which can reduce the time required from a state in which a cap abuts on a liquid ejecting head to flushing and which can suppress the scattering of mist in subsequent flushing.

According to an aspect of the invention, there is provided a liquid ejecting apparatus including: a liquid ejecting head for ejecting a liquid; a cap being able to abut on a nozzle forming surface of the liquid ejecting head so as to surround a nozzle; a cap holder for supporting the cap with a biasing unit such that the cap can be biased toward the liquid ejecting head, the cap holder being provided so as to be able to be moved in a first direction in which the cap is moved toward and away from the liquid ejecting head; a carrier provided so as to be able to be reciprocated in a second direction orthogonally intersecting the first direction, the carrier being reciprocated in the second direction to reciprocate the cap holder in the first direction with a cam mechanism in order to position the cap at an abutting position in which the cap abuts on the liquid ejecting head and at a flushing position in which the cap is spaced apart from the liquid ejecting head; and a driving unit for moving the carrier. The driving unit moves the cap to a first flushing position in cases where the cap is moved from the abutting position to the flushing position, whereas the driving unit moves the cap to a second flushing position in cases where the cap is moved from a non-abutting position to the flushing position, the second flushing position being adjacent to the liquid ejecting head relative to the first flushing position.

In this configuration, in cases where the cap is moved from the abutting position to the flushing position, the driving unit moves the cap to the first flushing position. Accordingly, the cap is directly moved from a state in which the cap abuts on the liquid ejecting head to the flushing position, so that the time before flushing can be reduced. On the other hand, in cases where the cap is moved from the non-abutting position to the flushing position, the driving unit moves the cap to the second flushing position which is in the vicinity of the liquid ejecting head relative to the first flushing position. In this case, because the biasing unit does not affect a position of the cap, the cap is accurately positioned, resulting in suppressing the scattering of mist during flushing.

It is preferable that the cam mechanism includes a cam groove formed on the carrier and includes a cam rod formed on the cap holder, the cam rod engaging with the cam groove. It is also preferable that the cam groove has a flat portion extending in the second direction and has an inclined portion.

It is preferable that the driving unit includes a motor for moving the carrier only by the rotation of the motor in a single direction. By virtue of this configuration, the rotation of the motor in another direction can be utilized for other object.

It is preferable the driving unit includes a motor for moving the carrier by the rotation of the motor in normal and reverse directions. By virtue of this configuration, the cap can be promptly moved to the second flushing position.

### BRIEF DESCRIPTION OF THE DRAWINGS

The invention will be described with reference to the accompanying drawings, wherein like numbers reference like elements.

FIG. 1 is a perspective view schematically illustrating a recording apparatus according to an embodiment.

FIG. 2 is a block diagram schematically illustrating a nozzle clogging detecting device.

FIG. 3 is a side view schematically illustrating a lifting and lowering mechanism for a cap and the operation thereof.

FIG. 4 is a flowchart illustrating the operation of a recording apparatus.

FIG. 5 is a side view illustrating a lifting and lowering mechanism for a cap for the explanation of the operation of a recording apparatus.

FIG. 6 is a side view illustrating a lifting and lowering mechanism for a cap for the explanation of the operation of a recording apparatus.

FIG. 7 is a side view illustrating a lifting and lowering mechanism for a cap for the explanation of the operation of a recording apparatus.

### DESCRIPTION OF EXEMPLARY EMBODIMENTS

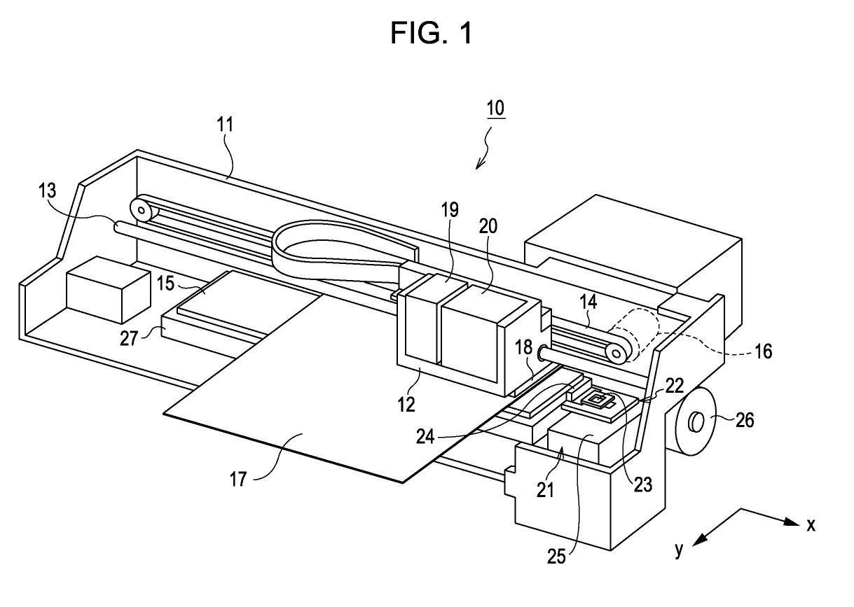

Embodiments of the invention will be described below with reference to accompanying drawings. FIG. 1 is a perspective view illustrating the basic configuration of a recording apparatus according to an embodiment. With reference to FIG. 1, an ink jet recording apparatus (hereinafter referred to as a recording apparatus 10) as a liquid ejecting apparatus has a base body 11 (a body frame).

The recording apparatus 10 is provided with a carriage 12 which is reciprocable with respect to the base body 11. The base body 11 is provided with an elongated guide shaft 13 of which both ends are fixed to the inside of the right and left side walls of the base body 11. The guide shaft 13 is inserted into the through hole of the carriage 12, and the carriage 12 is guided along the guide shaft 13. In addition, the carriage 12 is fastened to part of a timing belt 14. Consequently, driving of a carriage motor 16 leads to driving of the timing belt 14, so that the carriage 12 is reciprocated in a main scanning direction (an X direction in FIG. 1) in parallel to a longitudinal direction of a platen 15 by the driving of the timing belt 14.

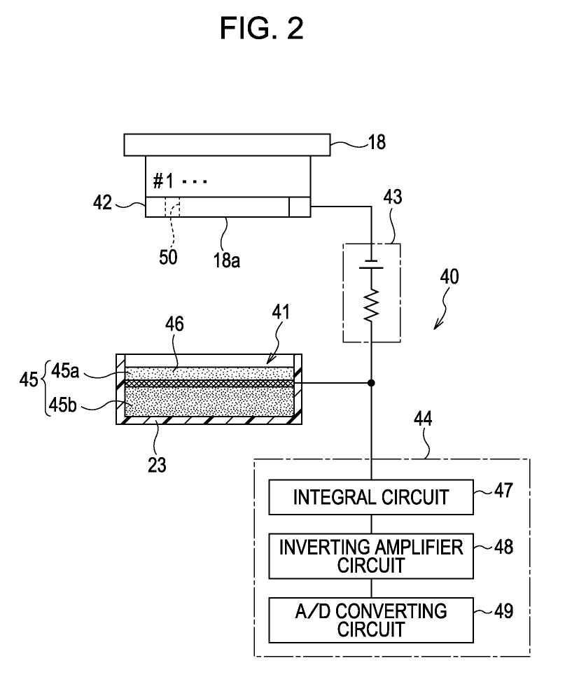

The carriage 12 is provided with an ink jet recording head (hereinafter referred to as a recording head 18) as a liquid ejecting head for ejecting a liquid on a surface (an under surface of the carriage 12) facing recording paper sheet 17 (a recording medium). A nozzle forming surface 18a (see FIG. 2) of the recording head 18 faces the recording paper sheet 17 at a slight distance. A black ink cartridge 19 and a color ink cartridge 20 in which three colors of ink (yellow, cyan, and magenta, for example) are individually contained are removably provided on the carriage 12, both of the cartridges 19 and 20 supplying the recording head 18 with ink as a liquid. It is configured such that both of the cartridges 19 and 20 can supply the recording head 18 with ink. A plurality of rows of nozzles (see FIG. 2) is formed on the nozzle forming surface 18a of the nozzle 18. Individual nozzles 50 can eject ink. A paper feed motor 26 drives each of the rollers (not shown) for transporting and ejecting the recording paper sheet 17, so that the recording paper sheet 17 is transported and ejected.

In a base body 11 shown in FIG. 1, a maintenance unit 22 is disposed in a non-print area (a home position 21) which is an end of a movement area of the carriage 12. The maintenance unit 22 is provided with a cap 23 and a wiping member 24 and can be moved in directions (vertical directions) toward and away from the recording head 18. In cases where the recording head 18 provided on the carriage 12 is positioned over the maintenance unit 22, the maintenance unit 22 lifts the cap 23 and the wiping member 24, so that the cap 23 can abut on the nozzle forming surface 18a of the recording head 18 so as to surround the nozzle 50. A suction pump 25 for applying a negative pressure to the interior space of the cap 23 is disposed at a position adjacent to the maintenance unit 22. In the embodiment, the suction pump is a tube pump and has a rotator, a cylinder body accommodating the rotator, and a flexible tube partially winding on the periphery of the rotator. In the suction pump 25, a plurality of rollers (a pressing member) provided on the periphery of the rotator irons out the tube in a single direction (moving while pressing the tube) by the rotation of the rotator, so that gas in the tube is forced out to generate a negative pressure in a space on the upstream side of the tube. An end of the tube used for suction is connected to the cap 23 of the maintenance unit 22, and another end of the tube used for exhaust is connected to a waste liquid tank 27 disposed under the platen 15.

In an idle period of the recording apparatus 10, the substantially square shaped cap 23 abuts on the nozzle forming surface 18a of the recording head 18 so as to surround the nozzle 50 to function as a lid for preventing the nozzle 50 from drying. In addition, the cap 23 has functions for forming space in which negative pressure from the suction pump 25 affects the recording head 18 and for drawing ink from the recording head 18. Furthermore, the cap 23 has a function as a tray for catching a droplet ejected from the recording head 18 in cases where preliminary ejection (flushing) in which ink is ejected from the recording head 18 to eject thickened ink and bubbles in nozzles is performed at a position in the vicinity of the home position 21 after receiving a driving signal which is not for print data. Moreover, nozzle clogging can be detected with the cap 23.

In the maintenance unit 22, the strip-shaped wiping member 24 which is made from rubber is disposed on the side of a print area adjacent to the cap 23 and extends above the maintenance unit 22. The wiping member 24 can wipe the nozzle forming surface 18a in cases where the carriage 12 is moved from the side of the home position 21 to the side of the print area after suction from the recording head 18 has finished. Consequently, ink adhered to the nozzle forming surface 18a can be scraped with the wiping member 24 after cleaning (suctioning), for example.

A nozzle clogging detecting device will be described with reference to FIG. 2. A nozzle clogging detecting device 40 includes the cap 23 disposed at the home position 21 as a portion for catching a droplet, a detection area 41 provided in the cap 23, a voltage application circuit 43 for applying a voltage between the detection area 41 and a nozzle substrate 42, and a voltage detection circuit 44 for detecting a voltage in the detection area 41. The cap 23 is a member having an opened upper surface and being in the form of a tray. The cap 23 is made of an elastic member such as an elastomer. An ink absorber 45 is disposed inside the cap 23. The ink absorber 45 includes an upper absorber 45a and a lower absorber 45b. An electrode member 46 in the form of a mesh is disposed between the upper absorber 45a and the lower absorber 45b. The upper absorber 45a is made of conductive sponge so as to have the same electric potential as that of the electrode member 46.

The sponge has high permeability such that an ink drop that lands thereon can be promptly transferred below, and a sponge of polyester-based polyurethane is used in the embodiment. The detection area 41 corresponds to a surface of the upper absorber 45a. The lower absorber 45b has high retention of ink relative to the upper absorber 45a and is made of nonwoven fabric such as felt. The electrode member 46 is formed as a lattice-shaped mesh made of metal such as stainless steel. Thereby, ink first absorbed in the upper absorber 45a is absorbed and retained in the lower absorber 45b through gaps in the lattice-shaped electrode member 46.

In the voltage application circuit 43, the electrode member 46 and the nozzle substrate 42 of the recording head 18 are electrically connected to each other through a direct-current power supply (400 V, for example) and a resistance device (1 MΩ, for example) such that the electrode member 46 is a positive electrode and the nozzle substrate is a negative electrode. Because the electrode member 46 is in contact with the upper absorber 45a having conductivity, a surface of the upper absorber 45a, in other words the detection area 41, has the same electric potential as that of the electrode member 46. The voltage detection circuit 44 includes an integral circuit 47 for integrating a voltage signal to output the resultant signal, an inverting amplifier circuit 48 for inverting and amplifying the signal output from the integral circuit 47 to output the resultant signal, and an A/D conversion circuit 49 for A/D converting the signal output from the inverting amplifier circuit 48 to output the resultant signal to a controller (not shown). In the integral circuit 47, because changes in voltage due to the splashing and landing of a single ink drop is small, changes in voltage due to the splashing and landing of a plurality of ink drops are integrated to output the result as a large change in voltage. In the inverting amplifier circuit 48, positive and negative polarities are inverted, and the signal output from an integral circuit in a predetermined gain is amplified to be output. In the A/D converter circuit 49, an analog signal output from the inverting amplifier circuit 48 is converted into a digital signal to output the converted signal as a detection signal to the controller.

A process for detecting nozzle clogging is performed with the nozzle clogging detecting device 40. In the detecting process, the recording head 18 is positioned above the cap 23, and the cap 23 is lifted to a position in which an ink drop ejected from the recording head 18 can be made to land on the detection area 41 with a lifting and lowering mechanism (a moving mechanism) described below, so that the detection area 41 faces the nozzle 50 of the recording head 18 in a non-contact state. A piezoelectric vibrator (not shown) is driven while the voltage application circuit 43 applies voltage between the nozzle substrate 42 and the electrode member 46, so that an ink drop is ejected from the nozzles 50. In this case, because the nozzle substrate 42 has a negative polarity, part of the negative electric charges in the nozzle substrate 42 is transferred to an ink drop, resulting in negatively charging the ejected ink drop. As the charged ink drop approaches the detection area 41 of the cap 23, positive electric charges increase in the detection area 41 (a surface of the upper absorber 45a) due to electrostatic induction. Consequently, induced voltage generated by the electrostatic induction increases the voltage between the nozzle substrate 42 and the electrode member 46 to more than an initial voltage value in a state in which an ink drop is not ejected. Subsequently, in cases where an ink drop lands on the upper absorber 45a, negative electric charges of the ink drop neutralize positive electric charges of the upper absorber 45a. As a result, the voltage between the nozzle substrate 42 and the electrode member 46 is decreased than an initial voltage value. Then, the voltage between the nozzle substrate 42 and the electrode member 46 returns to an initial voltage value.

The amplitude of an output signal in this case depends on the voltage applied between the recording head 18 and the electrode member 46, the distance between the recording head 18 (the nozzles 50) and the upper absorber 45a (detection area 41), the existence or non-existence of a splashed ink drop, and the size thereof. Accordingly, because the amplitude of an output signal becomes smaller than normal amplitude in cases where an ink drop does not splash and an ink drop is smaller than a predetermined drop size due to clogging of the nozzles 50, it is possible to determine whether the nozzles 50 are clogged or not depending on the amplitude of an output signal. In this case, because the amplitude of an output signal in a single ejection of an ink drop is significantly small, multiple ejections of ink drops (three ejections, for example) are performed to retrieve an output signal as an integral value of the signal amplitudes of the multiple ejections of the ink drops.

In the detection of nozzle clogging, all of the nozzles 50 formed on the recording head 18 are examined for the existence or non-existence of clogging. Once the examination starts, the carriage motor 16 is first driven to move the carriage 12 such that nozzle rows which are examination objects among the nozzle rows of the recording head 18 face an examination position, and a charged ink drop is ejected from a single nozzle 50 among the nozzle rows which are examination objects at an ejection frequency of one segment (corresponding to three ejections).

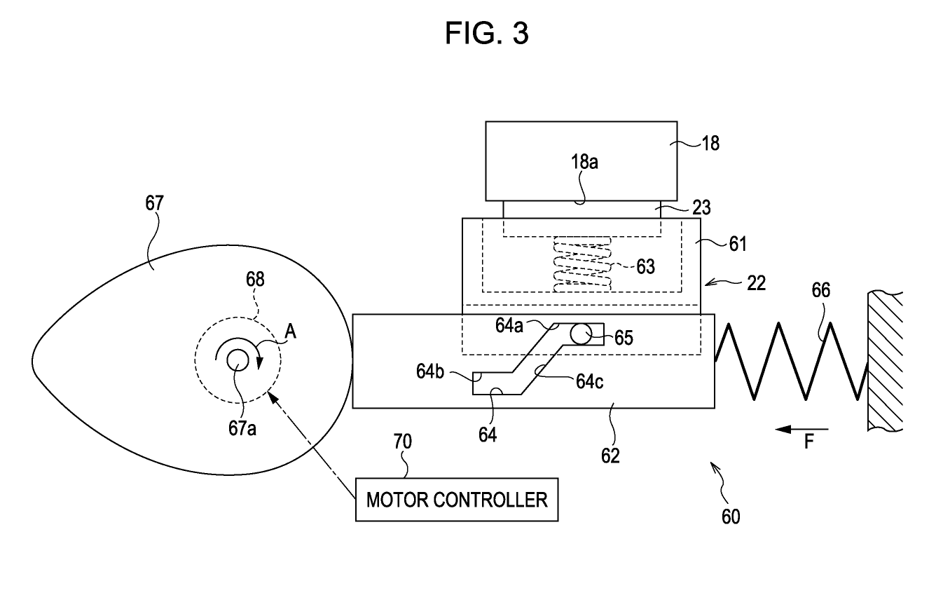

A lifting and lowering mechanism 60 for the cap 23 will be described with reference to FIG. 3. With reference to FIG. 3, the lifting mechanism 60 includes a cap holder 61 and a carrier 62 included in the maintenance unit 22. The cap holder 61 has an opened upper surface and a square shape. The cap 23 is disposed inside the cap holder 61. The cap holder 61 supports the cap 23 with a coil spring 63 as a biasing unit. By virtue of the coil spring 63, the cap 23 can be biased toward the recording head 18 above the cap 23. In addition, the cap holder 61 is provided so as to be able to be moved with a guide member (not shown) in vertical directions in which the cap 23 moves toward and away from the recording head 18.

The carrier 62 has an opened upper surface and a square shape. The carrier 62 is provided so as to be able to be reciprocated with a guide member (not shown) in horizontal directions (left and right directions in FIG. 3). In other words, the vertical directions in which the cap 23 moves toward and away from the recording head 18 are first directions, and the horizontal directions orthogonally intersecting the vertical directions are second directions. The carrier 62 can be reciprocated in the second directions.

The lower part of the cap holder 61 is disposed inside the carrier 62. The carrier 62 is connected to the cap holder 61 by a cam mechanism. The cam mechanism includes a cam groove 64 formed on a side wall of the carrier 62 and a cam rod 65 projecting from a side wall of the cap holder 61. The cam groove 64 includes an upper flat portion 64a, a lower flat portion 64b, and an inclined portion 64c connected therebetween. The upper flat portion 64a extends in the horizontal directions on the right side of the carrier 62. The lower flat portion 64b extends in the horizontal directions on the left side of the carrier 62 at a position lower than the upper flat portion 64a. The inclined portion 64c linearly connects the left end of the upper flat portion 64a to the right end of the lower flat portion 64b. The inclined portion 64c extends at a tilt angle of approximately 45 degrees. The cam rod 65 engages with the cam groove 64 of the carrier 62 and is guided along the cam groove 64.

The carrier 62 is reciprocated in the horizontal directions with the cam mechanism, so that the cap holder 61 can be reciprocated in the vertical directions. Thereby, the cap 23 can be positioned in an abutting position (a capping position) in which the cap 23 abuts on the recording head 18 and in a flushing position in which the cap 23 is spaced apart from the recording head 18.

The carrier 62 is biased with a spring 66 toward the left side in FIG. 3. A cam 67 is disposed on the left side of the carrier 62. The left surface of the carrier 62 is in contact with the periphery of the cam 67 with the spring 66. A drive power is transmitted from a maintenance motor 68 to a shaft 67a of the cam 67 through a reduction gear (not shown). The cam 67 rotates in an A direction shown in FIG. 3 in accordance with the rotational drive of the maintenance motor 68 in a normal direction. The carrier 62 moves from side to side in accordance with the rotation of the cam 67. The maintenance motor 68 can be rotationally driven in the normal direction to move the carrier 62 in the horizontal direction. Furthermore, the maintenance motor 68 can be rotationally driven in an inverse direction by disengaging a clutch (not shown) to drive the suction pump 25. A controller 70 controls the maintenance motor 68.

The maintenance motor 68 is driven to move the carrier 62, so that the cam rod 65 of the cap holder 61 is moved along the cam groove 64 of the carrier 62. Thereby, the cap holder 61 can be moved in the vertical direction.

In the embodiment, a driving unit for moving the carrier 62 includes the spring 66, the cam 67, the maintenance motor 68, and the motor controller 70.

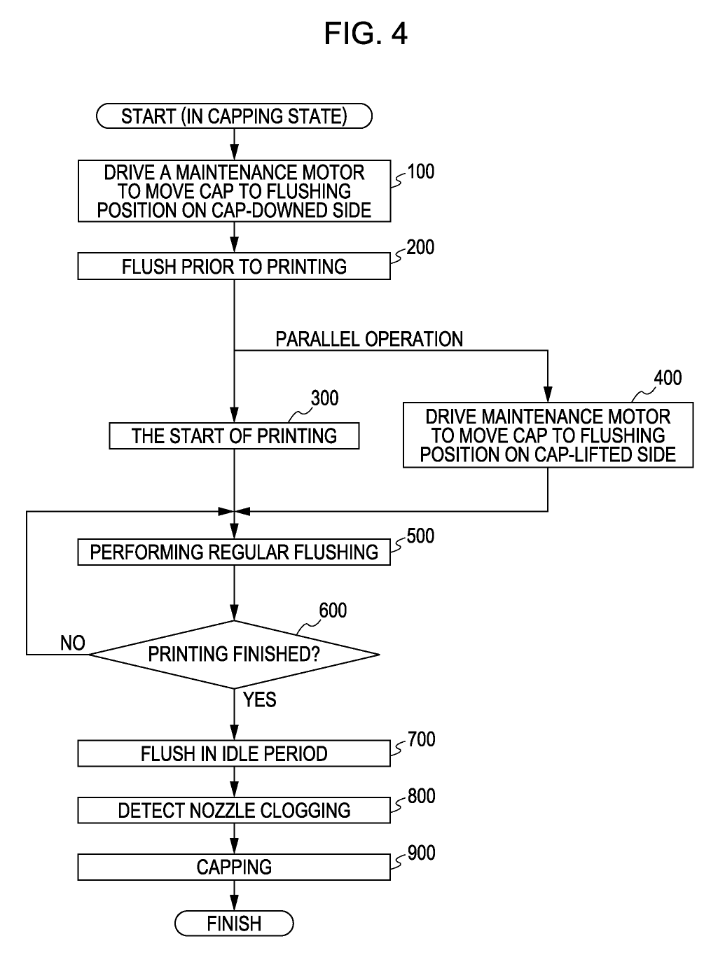

The operation of the recording apparatus 10 will be described with reference to FIG. 4. With reference to FIG. 4, the recording apparatus 10 is in a capping state in the case of the absence of a printing instruction. Specifically, in an idle period before receiving a printing instruction, the motor controller 70 controls the maintenance motor 68 to position the cam rod 65 of the cap holder 61 in the upper flat portion 64a of the cam groove 64 of the carrier 62 as shown in FIG. 3, so that the cap holder 61 approaches the recording head 18, and the cap 23 comes to be at the abutting position in which the cap 23 abuts on the recording head 18 with the coil spring 63. In other words, the cap 23 is biased toward the recording head 18 with the coil spring 63, so that the cap 23 abuts on the nozzle forming surface 18a of the recording head 18 so as to surround the nozzle 50. Consequently, a nozzle can be prevented from drying.

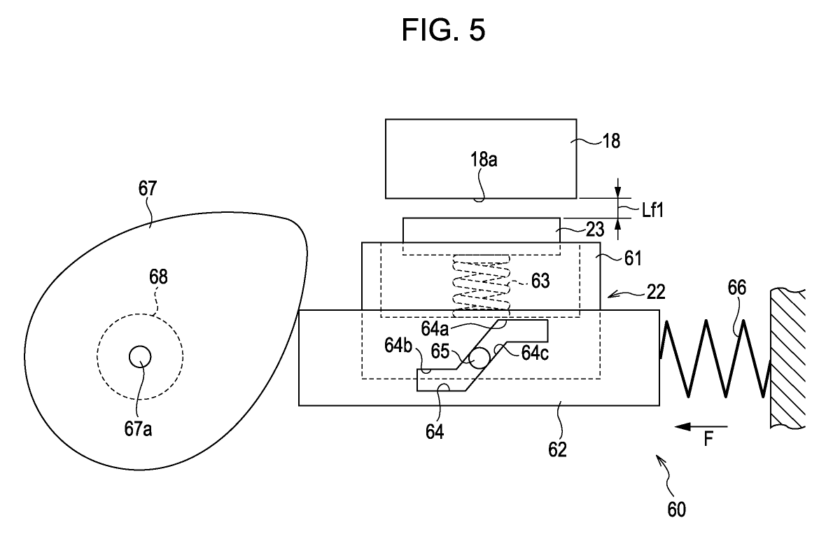

In cases where a printing instruction is issued (a printing instruction is received), in a process 100 shown in FIG. 4, the motor controller 70 controls the maintenance motor 68 to drive the cam 67 in the direction of the operation of the cam (the A direction in FIG. 3), so that the carrier 62 is moved from a position in which the carrier 62 has been disposed in the idle period, and then the cam rod 65 is positioned in the inclined portion 64c of the cam groove 64 of the carrier 62 as shown in FIG. 5. Thereby, the cap 23 is positioned at the flushing position in which the cap 23 is spaced apart from the recording head 18. In FIG. 5, the cap 23 is spaced apart from the recording head 18 by a distance Lf1. In a process 200 in FIG. 4, flushing prior to the start of printing is performed to remove thickened ink in the nozzle 50 by performing preliminary ejection.

In cases where the cap 23 is moved from the abutting position in which the cap 23 abuts on the recording head 18 to the flushing position with the motor controller 70, the maintenance motor 68, the cam 67, and the spring 66 in this way, the cap 23 is moved to a first flushing position shown in FIG. 5.

Subsequently, printing is started in a process 300 in FIG. 4. During the printing, in a process 400, the motor controller 70 controls the maintenance motor 68 to drive the cam 67 in the direction of the operation of the cam (the A direction in FIG. 3), and the cam 67 is driven only at a predetermined angle θ1. Consequently, the orientation of the cam 67 is changed by a predetermined angle Δθ relative to a state shown in FIG. 5, and then the carrier 62 is moved to a left side by a predetermined length ΔL, and then the cap holder 61 is moved upward by a predetermined height ΔH.

In cases where the cap 23 is moved from a non-abutting position in which the cap 23 does not abut on the recording head 18 to the flushing position with the motor controller 70, maintenance motor 68, cam 67, and spring 66 in this way, the cap 23 is moved to a second flushing position adjacent to the recording head 18 rather than the first flushing position, so that the cap 23 is spaced apart from the recording head 18 by a predetermined distance Lf2.

Subsequently, in a process 500 in FIG. 4, regular flushing during printing is performed. Specifically, the regular flushing during printing is performed in a state in which the cap 23 has been moved from a flushing position in which the flushing prior to the start of printing has been performed to another flushing position to which the cap 23 is lifted.

In a process 600 in FIG. 4, it is determined whether printing has been finished or not, and the regular flushing in the process 500 is performed until the printing is finished. The regular flushing is performed every 10 seconds to one minute, for example.

In cases where it is determined that printing has been finished in the process 600, flushing before capping in an idle period is performed in a process 700. In other words, flushing is performed in order to retain humidity inside the cap 23 prior to capping.

Then, in a process 800, the detection of nozzle clogging described with reference to FIG. 2 is performed. In cases where nozzle clogging has been detected in the detection process, cleaning is performed (performing ink suction, for example). Capping is performed in a process 900 in FIG. 4. Specifically, the motor controller 70 drives the maintenance motor 68 in the direction of the operation of the cam (the A direction in FIG. 3) to position the cam rod 65 of the cap holder 61 at the upper flat portion 64a of the cam groove 64 of the carrier 62 as shown in FIG. 3. Consequently, the cap 23 abuts on the nozzle forming surface 18a of the recording head 18 so as to surround the nozzle 50.

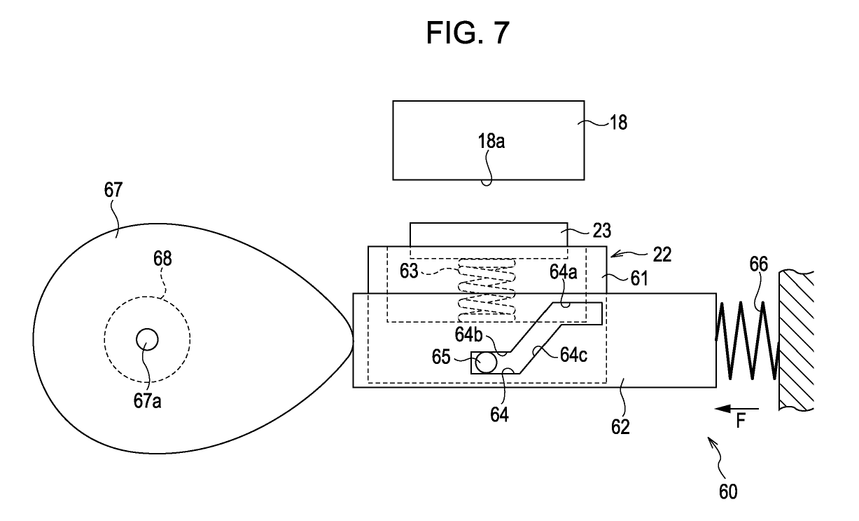

After ink suction has been performed, the motor controller 70 controls the maintenance motor 68 to position the cam rod 65 of the cap holder 61 at the lower flat portion 64b of the cam groove 64 of the carrier 62 as shown in FIG. 7 (at a position for wiping). In this state, the carriage 12 is moved to wipe the nozzle forming surface 18a of the recording head 18 with the wiping member 24, resulting in removal of an ink blot.

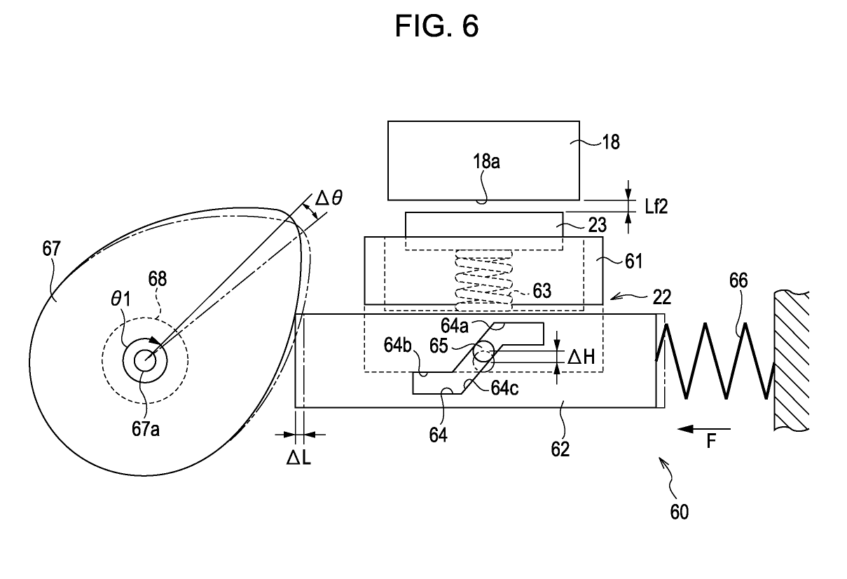

According to the above embodiment, advantages described below can be obtained. (1) In cases where flushing in which the cap 23 is moved from the abutting position (a capping position) shown in FIG. 3 to a flushing position is performed prior to the start of printing, the cap 23 is moved to the first flushing position shown in FIG. 5. On the other hand, in cases where the cap 23 is subsequently moved from a non-abutting position to a flushing position (regular flushing during printing and flushing in an idle period, for example), the cap 23 is moved to the second flushing position shown in FIG. 6 which is adjacent to the recording head 18 than the first flushing position. As a result, the cap 23 abutting on the recording head 18 is directly moved to a flushing position, so that the time before flushing can be reduced, and the splash of mist of ink can be suppressed in a subsequent flushing.

The above advantage will be described in detail below. In cases where the cap 23 (the cap holder 61) is lifted after the cap 23 is brought down from the capping position shown in FIG. 3 beyond a position in which flushing is performed, the starting time from receiving a printing instruction (a printing start instruction) to actually starting printing on paper is increased. In particular, in cases where the vertical movement of the cap 23 and a wiping operation is performed only by the rotation of a motor in a single direction as in the case of the embodiment, the cap 23 can be lifted only after the cap 23 has been first brought down completely and the wiping operation has been started, resulting in the further increase of time. In the embodiment, flushing is performed prior to the start of printing at a flushing position to which the cap 23 is brought down, resulting in the decrease of the starting time.

In cases where the carrier 62 is rightward moved from a capping state shown in FIG. 3 to bring down the cap holder 61 after receiving a printing instruction (a printing start instruction), the cap holder 61 is swiftly brought down due to a downward spring load when the cam rod 65 of the cap holder 61 is released from a flat area (the upper flat portion 64a) of the cam groove 64 of the carrier 62, so that it is difficult to accurately stop the cap holder 61 at a predetermined position (the flushing position). In cases where a position of the cap 23 is brought down considerably, a distance between the cap 23 and the recording head 18 is increased, so that ink drops cannot land on the cap 23 during flushing, leading to a tendency to generate mist. In particular, mist is an important problem in an ink jet recording apparatus which is for business purpose and performs a large number of printing in lifetime. For example, in cases where mist adheres to an encoder scale of a carriage, the false operation of the carriage is likely caused. Furthermore, because there is a tendency that a spring load for a cap is increased in accordance with increase in size of a recording head in order to increase speed of the operation of a recording apparatus, the generation of mist becomes more significant as a recording apparatus advances in performance. In the embodiment, in the case of a regular flushing during printing, the cap 23 is lifted to a flushing position shown in FIG. 6. In this case, because the spring 63 does not affect a position of the cap 23, the cap 23 can be accurately stopped so as to be at a predetermined height, resulting in the suppression of the scattering of mist during flushing.

In the case of a mechanism in which the vertical movement of the cap 23 and wiping operation are performed only by the rotation of a motor in a single direction, the cap is lifted to perform capping again after the cap has been first brought down completely from a capping state and the wiping operation has been started. However, such operations have been performed during printing, and then the cap 23 is waited at a position to which the cap is lifted, so that the time for capping again after printing has finished can be decreased. Consequently, a recording apparatus can be prevented from being left in a non-capping state which is caused by turning the power of the recording apparatus off before capping is performed after printing has finished.

(2) Because the driving unit includes a motor (the maintenance motor 68) for moving the carrier 62 only by the rotation in a single direction, the rotation of the motor in another direction can be used for other object. In the embodiment, the suction pump 25 can be driven.

In addition, the above embodiments may be modified as described below. Although the carrier 62 is moved in the horizontal direction by rotating the cam 67 to vertically move (bringing up and down) the cap 23 in FIG. 3, it is not limited to this mechanism. It may be other mechanism in which, for example, the carrier 62 is moved in the horizontal directions with a rack and pinion to vertically move (bringing up and down) the cap 23.

Although a motor for moving the carrier 62 (the cap 23) moves the carrier 62 only by the rotation thereof in a single direction, the carrier 62 may be moved by the rotation of the motor in normal and reverse directions. Specifically, in the process 400 in FIG. 4, the cap 23 may be lifted by rotating a motor in a reverse direction to be led to a state shown in FIG. 6. In cases where the driving unit includes a motor (a maintenance motor) for moving the carrier 62 by the rotation thereof in the normal and reverse directions as described above, the cap 23 can be promptly moved from the first flushing position to the second flushing position. In other words, in cases where the cap 23 is moved only by the rotation of a motor in a single direction, the time is required in order that the cap 23 is moved from a state shown in FIG. 5 in which the cap 23 has been released from a capping position to a state shown in FIG. 6, but this required time can be reduced.

Although an ink jet recording apparatus is employed in the above embodiment, a liquid ejecting apparatus for spraying and ejecting a liquid other than ink may be employed. It can be applied to various liquid ejecting apparatuses including a liquid ejecting head for ejecting a slight amount of a droplet. The term “droplet” means a liquid state ejected from the liquid ejecting apparatus and also includes ones having a grain shape and a teardrop shape and trailing in the form of string. The “liquid” used herein may be a material which can be ejected from a liquid ejecting apparatus. For example, it may be a material which is in a liquid phase, the material not only including fluid or a liquid as one state of a substance such as a liquid having high or low viscosity, sol, gel, water, other inorganic solvent, organic solvent, solution, liquid resin, and liquid metal (metal melt), but including one that particles of functional materials composed of a solid such as a colorant and metallic particle is dissolved, dispersed, or mixed in a solvent. A typical example of a liquid includes ink described in the above embodiment and liquid crystal. The term “ink” used herein includes various liquid compositions such as common aqueous ink, oil-based ink, gel ink, and hot melt ink. The illustrative embodiment of a liquid ejecting apparatus may includes, for example, a liquid crystal display, an electro luminescent (EL) display, a surface-emitting display, a liquid ejecting apparatus for ejecting liquid containing materials such as a electrode material and a color material, which are used for manufacturing a color filter, in the form of dispersing and dissolving, a liquid ejecting apparatus for ejecting a living organic material used for manufacturing a bio chip, a liquid ejecting apparatus used as a precision pipette for ejecting a liquid as a specimen, a printing apparatus, and a micro dispenser. Furthermore, it may employ a liquid ejecting apparatus for accurately ejecting a lubricant to a precision instrument such as a watch and a camera, a liquid ejecting apparatus for ejecting a transparent liquid resin such as an ultraviolet curable resin onto a substrate in order to produce a micro-hemispherical lens (an optical lens) used for an optical communication device, and a liquid ejecting apparatus for ejecting acidic or alkaline etchant in order to etch a substrate or the like. The invention may be applied any one of the liquid ejecting apparatuses described above.

What is claimed is:

1. A liquid ejecting apparatus comprising:
a liquid ejecting head for ejecting a liquid;
a cap being able to abut on a nozzle forming surface of the liquid ejecting head so as to surround a nozzle;
a cap holder for supporting the cap with a biasing unit such that the cap can be biased toward the liquid ejecting head, the cap holder being provided so as to be able to be moved in first directions in which the cap is moved toward and away from the liquid ejecting head;
a carrier provided so as to be able to be reciprocated in second directions orthogonally intersecting the first direction, the carrier being reciprocated in the second directions to reciprocate the cap holder in the first directions with a cam mechanism in order to position the cap at an abutting position in which the cap abuts on the liquid ejecting head and at a flushing position in which the cap is spaced apart from the liquid ejecting head; and
a driving unit for moving the carrier,
wherein the driving unit moves the cap to a first flushing position in cases where the cap is moved from the abutting position to the flushing position, whereas the driving unit moves the cap to a second flushing position in cases where the cap is moved from a non-abutting position to the flushing position, the second flushing position being adjacent to the liquid ejecting head relative to the first flushing position.

2. The liquid ejecting apparatus according to claim 1, wherein the cam mechanism includes a cam groove formed on the carrier and includes a cam rod formed on the cap holder, the cam rod engaging with the cam groove,
wherein the cam groove has a flat portion extending in the second direction and has an inclined portion.

3. The liquid ejecting apparatus according to claim 1, wherein the driving unit includes a motor for moving the carrier only by the rotation of the motor in a single direction.

4. The liquid ejecting apparatus according to claim 1, wherein the driving unit includes a motor for moving the carrier by the rotation of the motor in normal and reverse directions.
